(19) United States
(12) Patent Application Publication
(10) Pub. No.: US 2025/0240646 A1
(43) Pub. Date: Jul. 24, 2025

(54) SELF-CONFIGURING SMART SURFACE

(71) Applicant: NEC Laboratories Europe GmbH, Heidelberg (DE)

(72) Inventors: Francesco DEVOTI, Heidelberg (DE); Antonio ALBANESE, Heidelberg (DE); Vincenzo SCIANCALEPORE, Heidelberg (DE); Xavier COSTA-PEREZ, Heidelberg (DE)

(21) Appl. No.: 18/697,739

(22) PCT Filed: Nov. 22, 2021
(86) PCT No.: PCT/EP2021/082525

§ 371 Date: Apr. 2, 2024

(30) Foreign Application Priority Data
Oct. 8, 2021 (EP) 21201713.1

(51) Int. Cl. H04W 24/02; H04B 7/04; H04B 7/06

(52) U.S. Cl. CPC H04W 24/02; H04B 7/04013; H04B 7/0626

(57) ABSTRACT

A method of self-configuration of a reconfigurable intelligent surface (RIS) for optimizing a gain of a reflected beam between a base station (BS) and a User Equipment (UE) includes acquiring, using power sensing capabilities of the RIS, a power profile through sequential activation of probing beams. An angular position of the BS and the UE is obtained by identifying power profile peaks in the acquired power profile. An optimal RIS configuration is computed locally according to the obtained angular position of the BS and U. The RIS is self-configured by setting the computed optimal RIS configuration.

### CROSS REFERENCE TO RELATED APPLICATIONS

This application is a U.S. National Phase application under 35 U.S.C. § 371 of International Application No. PCT/EP2021/082525, filed on Nov. 22, 2021, and claims benefit to European Patent Application No. EP 21201713.1, filed on Oct. 8, 2021. The International Application was published in English on Apr. 13, 2023 as WO 2023/057082 A1 under PCT Article 21(2).

### FIELD

The present invention relates to a method of self-configuration of a reconfigurable intelligent surface, RIS, for optimizing a gain of a reflected beam between a base station, BS, and a User Equipment, UE.

Furthermore, the present invention relates to a reconfigurable intelligent surface, RIS, for deployment in a cellular radio network for optimizing a gain of a reflected beam between a base station, BS, and a User Equipment.

### BACKGROUND

The ever-growing need for unprecedented network performance calls for a revolutionary technology enabling control on the way electromagnetic waves propagate in the surrounding environment. In this regard, reconfigurable intelligent surfaces (RISs) have drawn vast interest as they can alter the radio propagation properties of the impinging signals in favor of specific directions, mimicking a mirror with controllable reflection and scattering properties.

FIG. 1 illustrates an example of RIS 100 according to the state of the art, equipped with a set of RF chains 110 to enable reception mode (cf. FIG. 1a). If RISs are not equipped with such additional hardware, i.e., only the reflective surface and the RIS controller 120 are present (cf. FIG. 1b), the RISs capabilities are limited to controlled signal reflection. The general concept of RIS is described, for instance, in Yuanwei Liu et al.: “Reconfigurable Intelligent Surfaces: Principles and Opportunities”, IEEE Communications Surveys & Tutorials, vol. 23, No. 3, 2021, which is hereby incorporated herein by reference.

The RIS controller 120 enables changing the configuration of its RIS 100 by properly setting its phase shifters. Different techniques are available to select the appropriate RISs configurations, depending on their capabilities and the available information on the deployment scenario. In particular, with known positions of all network devices, namely UEs, base stations, and RISs, the RISs configuration can be optimized through geometric considerations. Alternatively, if some RISs are capable of working in reception mode, optimization techniques may leverage on the knowledge of their received signals (by means of their RF chains) to perform their optimal configuration. Finally, the RISs settings can be chosen from a set of factory-preset configurations known as a codebook. The codebook-based approach is typical of commercial off-the-shelf (COTS) hardware, which selects the preset configuration providing the highest receive power among all codebook configurations via the so-called beam-alignment procedure.

In the most common envisioned application, RISs create and dynamically control a reflected path between the base station (BS) and the user equipment (UE), and enable their communication even in case the direct BS-UE link is blocked by an obstacle. This operation mode may require estimating the interested wireless channels (at least their statistics), namely the BS-RIS and the RIS-UE channels, in order to properly configure the phase shifts introduced at the RIS and deliver optimal throughput performances. Indeed, the RIS paradigm turns the adversary black-box channel concept into a controllable variable where a massive number of smart surfaces equipped with low-cost and low-complexity electronics allow optimizing the wireless propagation, thus in turn unleashing the over-the-top performances promised by the future beyond-5G network generations.

All approaches to RIS configuration available in the literature may require a control channel whose main drawbacks are an increased system complexity and an increased communication overhead. Therefore, RIS deployment may necessitate additional infrastructural adaption to guarantee the reliability of such control channel, which may not be straightforward or economically feasible. As a direct result, there is no currently viable option for a plug-and-play RIS deployment, namely a control mechanism for the RIS should always be either already in place before deployment or be concurrently planned.

In Pei, Xilong, et al. “RIS-aided wireless communications: Prototyping, adaptive beamforming, and indoor/outdoor field trials”, arXiv preprint arXiv: 2103.00534 (2021), the authors aim at alleviating the control channel overhead problem by proposing a RIS optimization algorithm in which the RIS cannot implement arbitrary configurations but rather only configurations belonging to a predefined codebook with a finite number of possible phase shifts. The selection of the configuration is based on power measurements performed by the UE receiver, which are sent back to the RIS over a feedback control channel.

### SUMMARY

In an embodiment, the present disclosure provides a method of self-configuration of a reconfigurable intelligent surface (RIS) for optimizing a gain of a reflected beam between a base station (BS) and a User Equipment (UE). The method comprises: acquiring, using power sensing capabilities of the RIS, a power profile through sequential activation of probing beams; obtaining an angular position of the BS and the UE by identifying power profile peaks in the acquired power profile; computing locally an optimal RIS configuration according to the obtained angular position of the BS and UE; and self-configuring the RIS by setting the computed optimal RIS configuration.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b are a schematic view illustrating the functionality of RIS in different operational modes with and without RF chains;

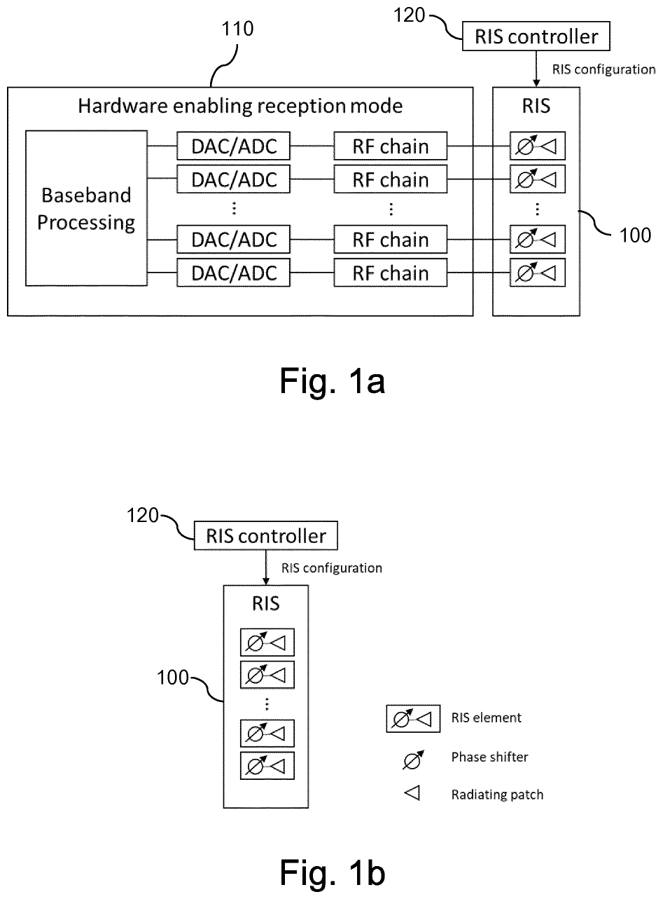

FIG. 2 is a schematic view illustrating schematics of a RIS aided optimization technique according to prior art;

FIG. 3 is a schematic view illustrating a power sensing enabled RIS, according to an embodiment of the invention; and

FIG. 4 is a schematic view illustrating a RIS self-configuration framework, according to an embodiment of the invention.

### DETAILED DESCRIPTION

In accordance with an embodiment, the present invention improves and further develops a method of self-configuration of a reconfigurable intelligent surface, RIS, and a RIS of the initially described type in such a way that no external control for the RISs deployed in a network may be required.

In accordance with another embodiment, the present invention provides a method of self-configuration of a reconfigurable intelligent surface, RIS, for optimizing a gain of a reflected beam between a base station, BS, and a User Equipment, UE. The method comprises acquiring, by means of power sensing capabilities of the RIS, a power profile through sequential activation of probing beams; obtaining the angular position of the BS and the UE by identifying power profile peaks in the acquired power profile; computing locally an optimal RIS configuration according to the identified angular position of the BS and UE; and self-configuring the RIS by setting the computed optimal RIS configuration.

Furthermore, in accordance with another embodiment, the present invention provides a reconfigurable intelligent surface, RIS, for deployment in a cellular radio network for optimizing a gain of a reflected beam between a base station, BS, and a User Equipment, UE, the RIS comprising a RIS controller including one or more processors that, alone or in combination, are configured to provide for the execution of the steps of triggering power sensing capabilities of the RIS to acquire a power profile through sequential activation of probing beams; obtaining the angular position of the BS and the UE by identifying power profile peaks in the acquired power profile; computing locally an optimal RIS configuration according to the identified angular position of the BS and UE; and self-configuring the RIS by setting the computed optimal RIS configuration.

It should be noted that although the present disclosure mainly uses 3GPP LTE terminology, the terms BS and UE as used herein are to be understand in the broadest sense, not limited to 3GPP LTE. In particular, the term UE may include any kind of mobile station, and the term BS may include any piece of equipment that facilitates wireless communication between user equipment and a network (e.g., BTS, NodeB, eNodeB, etc.).

With embodiments of the present invention, a RIS-aided network is provided wherein every RIS is self-configuring and may require no external control, thereby solving the problem of setting up a control framework for the deployed RISs and in turn dramatically decreasing the related network operations complexity and deployment costs. In this context, it is worth pointing out that by removing the need for a control channel, the solution according to embodiments of the invention implicitly removes the need for any external (centralized) control, thereby making the RIS totally autonomous. Furthermore, RIS configuration may not require any specific expertise.

According to embodiments, the present invention provides a plug-and-play solution for RISs, which may not require a dedicated control channel. RISs can self-configure to adaptively find the best reflected beam direction for maximizing the transmission performance. To this end, embodiments of the invention exploit RF power measurements performed locally at each RIS to estimate the direction of arrival of impinging signals on the RIS and perform self-configuration accordingly. According to embodiments, the RIS makes use of a probing codebook to execute power measurements directly at the RIS, without the intervention of any external device nor the need for a feedback control channel, thus making the RIS completely transparent to the network from the control point of view.

The solution according to embodiments of the present invention allows RIS without control channel to perform self-configuration by optimizing the gain of the reflected path between the BS and the UE through the RIS providing enhanced channel conditions to sustain BS-UE communication. According to embodiments, RIS self-configuration is enabled by periodically performing angular power profile acquisition and accordingly estimate the angular positions of the BSs and the UEs in order to acquire channel information to configure the RIS. For instance, periodical power profile acquisition may be realized through the sequential activation of probing beams, e.g., as included in the RIS's probing codebook. A limited-cost RIS hardware configuration (including electronic circuits with limited capabilities) may be used that provides power sensing capabilities to the RIS in order to obtain the necessary information on the angular positions of BSs and UEs to perform RIS self-configuration.

There are several ways how to design and further develop the teaching of the present invention in an advantageous way. To this end, it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

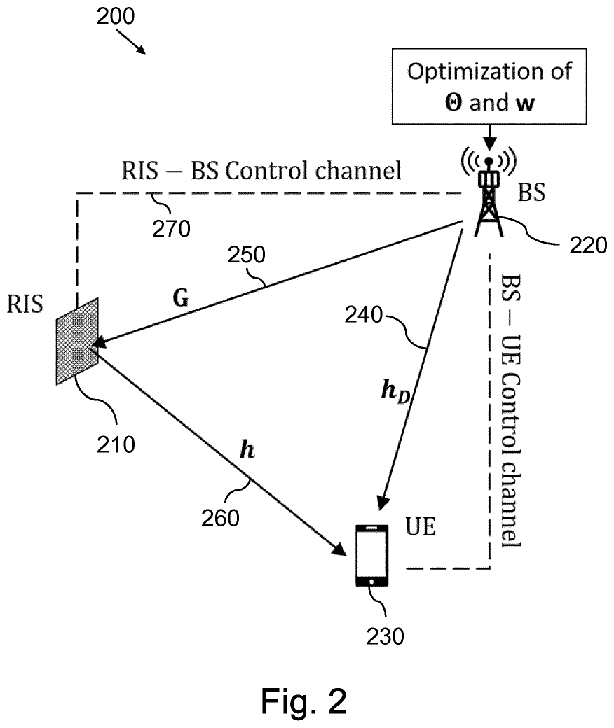

FIG. 2 schematically shows a typical RIS deployment 200 according to prior art. Here, the RIS 210 creates and dynamically controls a reflected path between a base station, BS 220, and a user equipment, UE 230, and enables their communication even in case the direct BS-UE link 240 is blocked by an obstacle. For enabling proper configuration of the phase shifts introduced at the RIS 210, such that optimal throughput performances are obtained, this operation mode may require estimating the BS-RIS and the RIS-UE channels 250, 260, respectively.

It should be noted that although the end-to-end BS-UE channel estimation may be performed by means of conventional channel estimation techniques (i.e., via the UE measurements reports transmitted to the BS 220), RIS 210 configuration mandates piece-wise estimation of the constituent BS-RIS and RIS-UE channels 250, 260, which is fundamentally different than end-to-end channel estimation, as it involves some processing capability at the RIS 210 and calls for a mean to propagate such information back to the BS 220. Indeed, in a typical single-UE scenario, and considering a RIS 210 with N elements and a BS 220 equipped with an M elements antenna, the RIS 210 configuration delivering the optimal throughput at a single-antenna UE 230 can be obtained by solving the following optimization problem:

$${max}_{Θ , w} \frac{{\vert ( {h}^{H} Θ G + {h}_{D}^{H} ) w \vert}^{2}}{{σ}_{n}^{2}} θ , w$$

$${s . t . \vert {Θ}_{ii} \vert}^{2} \leq 1 , i = 1 , … , N$$

$${‖ w ‖}^{2} \leq P .$$

where h∈ [symbol] ^{N×1} and G∈ [symbol] ^{N×M} are the RIS-UE and BS-RIS channels 250, 260, respectively, w∈ [symbol] ^{M×1} is the BS 220 transmit precoder, Θ∈ [symbol] ^{N×N} is the RIS 210 configuration, h_{D}∈ [symbol] ^{M×1} is the direct BS-UE channel 240 and σₙ² is the noise power, and P is the transmission power at the BS 220 (for reference, cf. Yang, Yifei, et al. “Intelligent reflecting surface meets OFDM: Protocol design and rate maximization”, IEEE Transactions on Communications 68.7 (2020): 4522-4535). It is worth pointing out that the solution of the optimization problem may require the knowledge of the G, h, hp channels.

Prior art techniques for RIS 210 configuration are centralized and thus, as depicted in FIG. 2, always rely on the availability of an out-of-band communication link, dubbed as control channel 270, typically working at lower frequencies. The control channel 270 enables information exchange between the RIS 210 controller and the BS 220, so as to propagate the piece-wise channel estimations performed at the RIS 210 to the BS 220, and instruct the RIS 210 controller, which is co-located with the RIS 210 and in charge of implementing the centrally computed RIS 210 configuration.

The need for such communication channel 270 results in i) increased system complexity to establish and maintain a control channel between BS 220 and RIS 210, ii) increased communication overhead, which recent studies have proved to be non-negligible, especially in the case of RIS 210 with a large number of elements to be controlled (for reference, cf. Zappone, Alessio, et al. “Overhead-aware design of reconfigurable intelligent surfaces in smart radio environments”, in IEEE Transactions on Wireless Communications 20.1 (2020): 126-141), iii) need of a channel estimation strategy to provide CSI (Channel State Information) for all the communication channels at the BS 220 to enable the optimization of BS 220 precoder and RIS 210 configuration (for reference, see Zheng, Beixiong, and Rui Zhang. “Intelligent reflecting surface-enhanced OFDM: Channel estimation and reflection optimization.” IEEE Wireless Communications Letters 9.4 (2019): 518-522).

All approaches to RIS configuration available in the literature may require a control channel whose main drawbacks are mentioned above. To overcome at least some of these drawbacks, embodiments of the present invention provide a RIS and a RIS-aided network wherein every RIS is self-configuring and may require no external control, thereby solving the problem of setting up a control framework for the deployed RISs and in turn dramatically decreasing the related network operations complexity and deployment costs. It is worth pointing out that by removing the need for a control channel, embodiments of the invention are implicitly removing the need for any external (centralized) control, thereby making the RIS totally autonomous.

Embodiments of the present invention provide a system that allows plug-and-play RISs deployment without an out-of-band control channel. Specifically, according to embodiments of the invention, this may be achieved by 1) a new channel estimation model at the RIS and/or 2) an autonomous RIS configuration methodology based only on the channel state information (CSI) of the BS-RIS and UE-RIS paths without involving an active control channel.

In accordance with embodiments of the invention, it has been recognized that, by removing every kind of external control, the RIS should be able to retrieve the minimal information that may be required to perform self-configuration. Therefore, in some embodiments the RISs is assumed to possess some power-sensing capabilities in addition to the option to change the reflection angle of the impinging signals according to the generalized Snell's law, namely in a controlled manner.

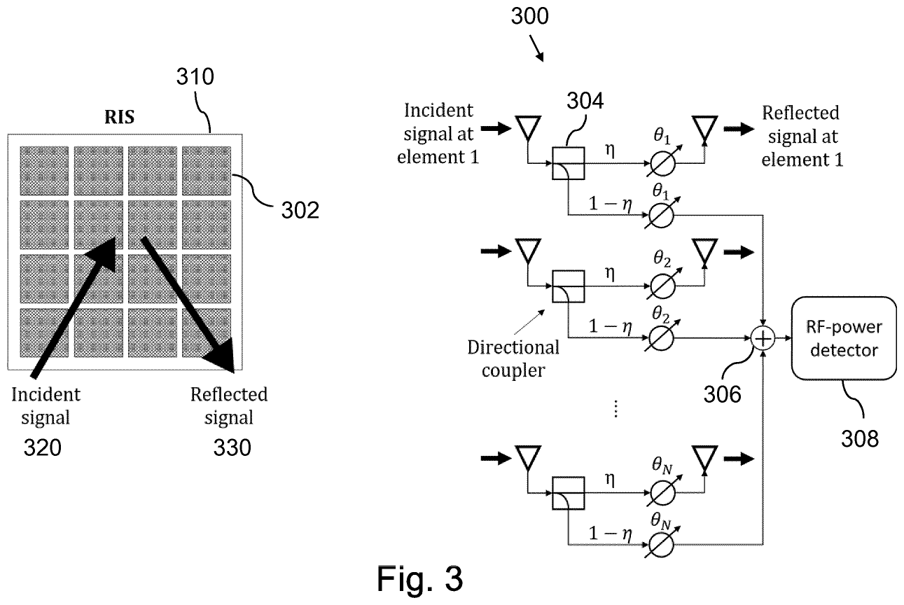

FIG. 3 depicts the structure of a RIS hardware configuration 300 to enable power sensing capabilities at the RIS 310 in accordance with embodiments of the present invention. In this context, it is noted that according to Alexandropoulos, George C., et al. “Hybrid reconfigurable intelligent metasurfaces: Enabling simultaneous tunable reflections and sensing for 6G wireless communications”, arXiv preprint arXiv: 2104.04690 (2021), each RIS element 302 is provided with a directional coupler 304 that splits an impinging signal 320 so that a portion n is reflected for communication—reflected signal 330—and a portion 1-η is absorbed for further processing. Differently from the implementation of the referenced document, wherein a practical implementation of such simultaneous energy reflection and absorption is provided together with a set of RF chains to enable CSI acquisition at the RIS, embodiments of the present invention consider a simpler hardware configuration in which the portion of absorbed signal at each element 302, instead of being processed by RF chains, is summed together by means of one or more RF combiners 306 and forwarded to an RF-power detector 308 that reveals the amount of power, as shown in FIG. 3.

It is worth pointing out that components such as the directional coupler 304 and the RF combiner 306 can be easily implemented by means of lumped components throughout the RIS RF-circuit, while the RF power detector 308 can be made, e.g., of a thermistor or a diode detector. Therefore, the additional hardware requirement may come with an almost negligible impact on the overall production cost if compared with RF-chains and digital signal processing hardware.

### RIS Self-Configuration

According to embodiments of the invention, the availability of an RF power detector, e.g. RF power detector 308 implemented in the embodiment of FIG. 3, is used as enabler that allows for self-configuration. In this context, the RF power detector 308 may be used to acquire a power profile through sequential activation of probing beams. According to an embodiment, the power profile may be acquired subsequent to the execution of a standard CSI acquisition procedure between the BS and the UE. This procedure guarantees that a self-configuring RIS will be exposed to signals transmitted by both BS and UE even if those entities are not aware of the RIS's presence. Possible CSI acquisition procedures that may be implemented are disclosed, e.g., in Kais Hassan et al.: “Channel Estimation Techniques for Millimeter-Wave Communication Systems: Achievements and Challenges”, in IEEE Open Journal of the Communications Society, vol. 1, pp. 1336-1363, 2020, doi: 10.1109/OJCOMS.2020.3015394, which is hereby incorporated herein by reference.

Following a standard CSI acquisition procedure, it is assumed that a periodical training phase takes place during which the BS and the UE transmit pilot symbols to establish and sustain the communication. The RIS can detect such power transmissions thanks to the RF power detector. The detected power form the BS (denoted PB) and the UE (denoted Pu) can be formulated as:

$${P}_{B} = ( 1 - η ) {\vert {v}^{H} Gws \vert}^{2} + {σ}_{n}^{2}$$

$${{P}_{U} = ( 1 - η ) \vert {v}^{H} hs \vert}^{2} + {σ}_{n}^{2}$$

where the vector v is introduced such that v^{H}=diag(Θ), and s is the pilot symbol.

In order to be self-configuring the RIS needs to infer the channels h and G only based on the measured power P_{B} and P_{U}. This operation is equivalent to finding the RIS configuration v that maximizes the received power from the BS and the UE, respectively. It can be easily seen that the RIS configuration that maximizes the value of P_{U} is v_{U}∈ [symbol] ^{N×1} with elements

$${v}_{U , i} = {e}^{j ∠ {h}_{i}}$$

and is corresponding to the RIS steering vector configuration pointing towards the UE.

Similarly, the RIS configuration that maximizes the value of P_{B} is V_{B}∈ [symbol] ^{N×1} with elements set to

$${v}_{B , i} = {e}^{j {∠ ( Gw )}_{i}}$$

that corresponds to the RIS steering vector pointing towards the BS, and is independent of the precoding. The knowledge of such configurations is directly linked with the angular position of the communicating devices as they reveal the desired incoming and reflecting direction of the signal. Therefore, they can be promptly used to compute the RIS configuration that maximizes the reflected energy from the BS to the UE.

To find such directions, embodiments of the present invention propose the use of a set of predefined RIS configurations, in particular probing codebook, whose corresponding steering vector maximizes the absorbed power coming from a specific direction. To obtain the angular position of the BS and the UE, RIS configurations in the probing codebook may be sequentially activated and the corresponding power sensed by the RF power detector may be collected. This probing process may be repeated multiple times and may be used to derive an angular power profile whose peaks correspond to the angular position of the BS and the UE. This information, which is equivalent to perfect CSI condition, may in turn be used to derive the optimal RIS configuration that maximizes the energy reflected from the BS to the UE, which may then be set to sustain the communication. Once the reflected path is established, the BS can detect the additional, potentially high gain, multipath component during standard channel sounding operation through the emission of pilot signal and exploit its availability with a proper configuration of the precoder.

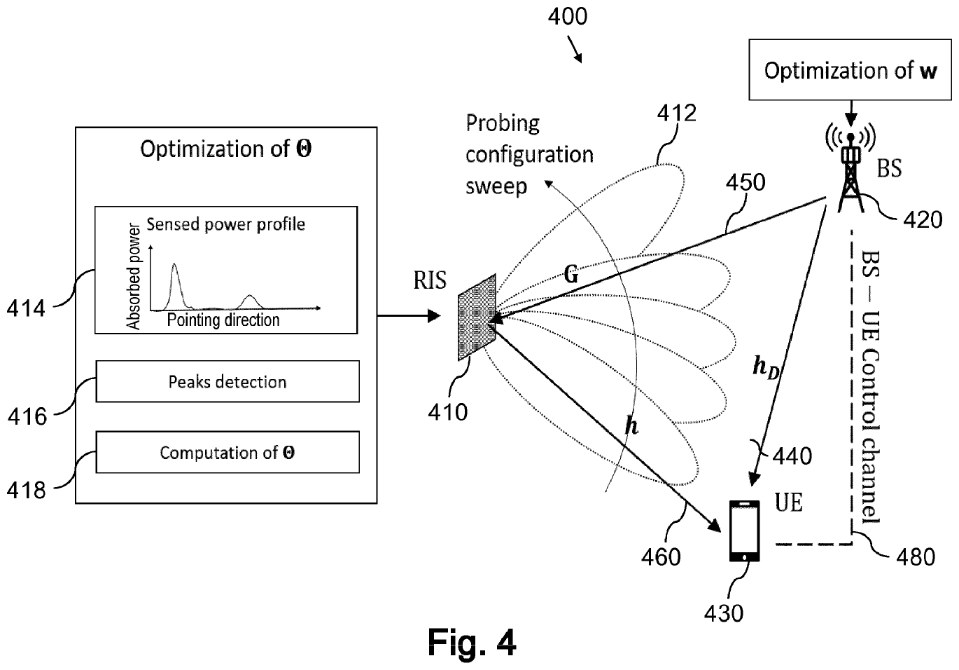

FIG. 4 depicts an overall operational RIS self-configuration framework 400 according to an embodiment of the present invention. According to this embodiment, the RIS 410 performs a series of RF-power measurements iteratively selecting a configuration from the probing codebook, which is activating beam patterns 412 in different and known directions, and collects such measurements to derive a sensed power profile. This operation is dubbed as probing configuration sweep and is repeated one or more times to acquire a sufficient number of measurements to derive a reliable power profile 414. Next, the RIS detects the peaks in the sensed power profile 414, as shown at 416, wherein the peaks of the power profile 414 correspond to the angular position of the BS 420 and the UE 430 with respect to the RIS 410. The RIS 410 controller therefore has enough information to derive the RIS 410 configuration maximizing the gain of the reflected path h_{R}^{H}=h^{H}ΘG, as shown at 418.

Once the RIS 410 configuration is set, the reflected path 450, 460 is then seen by the BS 420 as an additional component of the multipath channel. Consequently, the additional reflected path 450, 460 can be detected by the standard channel sounding procedures involving BS 420 and UE 430 devices, and exploited with classical methods of precoder optimization, thus making the presence of the RIS 410 completely transparent to the network.

In a single-UE scenario, the SNR can be written as

$$SNR = \frac{{\vert ( {h}^{H} Θ G + {h}_{D}^{H} ) w \vert}^{2}}{{σ}_{n}^{2}}$$

where the UE index k is omitted for simplicity. The numerator above can be reformulated as

$${\vert {z}_{R} {v}^{H} \hat{h} + {z}_{D} \vert}^{2} ,$$

with z_{R}=\sqrt{γ(b, r)}a_{BS}(r)w∈ [symbol] denoting the reflected path 450, 460 between the BS 420 and the UE 430 for a given precoder at the BS 420, where \sqrt{γ(b, r)} represents the pathloss between the BS 420 and the RIS 410, and a_{BS}(r) is the array response vector at the RIS 410. Besides, z_{D}=\sqrt{γ(b, u)}h_{D}^{H}w∈ [symbol] indicates the direct path between the BS 420 and the UE 430 with \sqrt{γ(b, u)} being the pathloss between the BS 420 and the UE 430, and v is the RIS 410 configuration vector, such that Θ=diag (v^{H}).

With the aid of some algebraic manipulations, the latter expression simplifies to

$${\vert {z}_{R} \vert}^{2} {v}^{H} \hat{h} {\hat{h}}^{H} v + {\vert {z}_{D} \vert}^{2} + 2 Re \{ {z}_{R} {v}^{H} \hat{h} {z}_{D}^{*} \} ,$$

which elucidates that the optimal RIS 410 configuration needs to fulfill two conditions: i) the maximization of the reflected path gain |z_{R}|²v^{H}ĥĥv and ii) the phase alignment between the direct path 440 and reflected paths 450, 460, i.e., z_{D} and z_{R}v^{Hĥ.}

Even though the RIS 410 has no knowledge of the direct path z_{D} and the lack of the control channel does not allow propagating such information to the RIS 410, the output v of the RIS 410 self-configuration solution according to embodiments of the invention delivers high performances, especially in cases where the BS-UE link 440 is negligible due to high pathloss (which is typical in mm-wave scenarios, where obstacles may easily completely block the signal propagation). Moreover, the optimality of the RIS 410 self-configuration solution according to embodiments of the invention is guaranteed if and only if the direct path 440 and reflect paths 450, 460 are aligned in phase.

Further to the single UE scenario described above, embodiments of the invention also provide a RIS 410 self-configuration solution that fully supports the multi-RIS scenario. Indeed, after performing self-configuration, each RIS in the scenario may create a reflected path between the BS and the proximal UEs, i.e. with each UE that can provide a significant peak in the sensed power in order to be detected.

For each UE, the end-to-end BS-UE channel consists of the superposition of the direct (if present) path and all available reflected paths through the involved RISs. However, as there is no control on the RISs, they are no different than standard reflectors except for their ability to focus the signals towards a specific direction, namely the one maximizing the receive power of the reflected path for the corresponding UE.

Consequently, the BS can directly perform end-to-end channel estimation by means of standard UEs feedbacks and execute proper transmit precoding even without knowing the RIS configuration nor the piece-wise BS-RIS and RIS-UE channels.

It should be noted that the crucial difference with respect to the presence of external control is that a managed RIS does not behave as a smart reflector only. Indeed, it also introduces an appropriate delay factor in the reflected path in order to guarantee phase alignment between the direct and reflected channels, therefore maximizing the overall receive SNR at the UE. However, as mentioned several times before, this is not physically achievable without an external control channel. However, the slight performance degradation introduced by removing the external control channel is the price to pay for a simpler plug-and-play deployment achieved in accordance with embodiments of the present invention.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method of self-configuration of a reconfigurable intelligent surface (RIS) for optimizing a gain of a reflected beam between a base station (BS) and a User Equipment (UE) the method comprising:
acquiring, using power sensing capabilities of the RIS, a power profile through sequential activation of probing beams;
obtaining an angular position of the BS and the UE by identifying power profile peaks in the acquired power profile;
computing locally an optimal RIS configuration according to the obtained angular position of the BS and UE; and
self-configuring the RIS by setting the computed optimal RIS configuration.

2: The method according to claim 1, wherein the sequential activation of probing beams is performed by selecting probing beams included in a probing codebook of the RIS.

3: The method according to claim 1, wherein power sensing is performed by the RIS using a number of directional couplers, RF combiners and, an RF power detector.

4: The method according to claim 1, wherein acquiring the power profile comprises:
splitting, at each RIS element by a respective directional coupler, an impinging signal into a portion η that is reflected for communication and a portion 1−η that is absorbed for further processing;
summing together, by at least one RF combiner, absorbed portions of all RIS elements and forwarding the sum to an RF power detector; and
revealing, by the RF power detector, an amount of power of the impinging signal.

5: The method according to claim 1, wherein the power profile is acquired during a training phase based on pilot symbols transmitted by the BS and the UE to establish and/or sustain communication.

6: The method according to claim 1, wherein the power profile is acquired subsequent to an execution of a standard CSI acquisition procedure.

7: The method according to claim 1, further comprising:
establishing a reflected path based on the computed optimal RIS configuration; and
detecting, by the BS, the reflected path as an additional component of a multipath channel via channel sounding operations.

8: The method according to claim 1, wherein, in a multi-RIS scenario, each RIS in the multi-RIS scenario, after performing self-configuration, creates a reflected path between the BS and any proximal UE that provides a detectable peak in the acquired power profile of the RIS.

9: The method according to claim 8, further comprising:
performing, by the BS, end-to-end channel estimation by using UE feedback.

10: The method according to claim 8, further comprising:
executing, by the BS, proper transmit precoding without knowing any RIS configurations nor any piece-wise BS-RIS and RIS-UE channels.

11: A reconfigurable intelligent surface for deployment in a cellular radio network for optimizing a gain of a reflected beam between a base station and a User Equipment (UE), the RIS comprising an RIS controller including one or more processors that, alone or in combination, are configured to provide for the execution of the steps of:
triggering power sensing capabilities of the RIS to acquire a power profile through sequential activation of probing beams;
obtaining an angular position of the BS and the UE by identifying power profile peaks in the acquired power profile;
computing locally an optimal RIS configuration according to the obtained angular position of the BS and UE; and
self-configuring the RIS by setting the computed optimal RIS configuration.

12: The RIS according to claim 11, wherein the power sensing capabilities comprise a number of directional couplers associated with each RIS element of the RIS, at least one RF combiner and an RF power detector.

13: The RIS according to claim 11, wherein, in order to acquire the power profile, a directional coupler associated with each RIS element is configured to split an impinging signal into a portion η that is reflected for communication and a portion 1−η that is absorbed for further processing.

14: The RIS according to claim 13, wherein the at least one RF combiner is configured to sum together the absorbed portions of all RIS elements and to forward the sum to the RF power detector, which is configured to reveal an amount of power of the incident signal.

15: The RIS according to claim 11, wherein the power sensing capabilities of the RIS are configured to;
acquire the power profile during a training phase based on pilot symbols transmitted by the BS and the UE to establish and/or sustain communication, and/or
acquire the power profile following a standard CSI acquisition procedure.
